(19) United States
(12) Patent Application Publication
(10) Pub. No.: US 2003/0018672 A1
(43) Pub. Date: Jan. 23, 2003

(54) System and method for fast median filters, with a predetermined number of elements, in processors

(75) Inventor: Richard Y. Chen, Croton-on-Hudson, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/908,195

(22) Filed: Jul. 18, 2001

(51) Int. Cl. G06F 7/00; G06F 17/10

(52) U.S. Cl. 708/202; 708/304

(57) ABSTRACT

A fast median filter and method is disclosed. The median filter used by a processor includes a predetermined number of median cells, each of the median cells is connected to an input and an output through a switching circuit and a means for determining the median of said predetermined number of median cells using only minimum (Min) and maximum (Max) operations of the processor.

### FIELD OF THE INVENTION

The present invention pertains generally to the field of median filters, and in particular, the invention relates to a system and method for a fast median filter with a predetermined number of elements for use by a processor.

### BACKGROUND OF THE INVENTION

In contemporary digital signal processing schemes it is often desirable to apply a median filter to process a signal to reduce impulse noise. Median filters are non-linear filters that can be used to achieve dramatic results in diverse applications such as in media-processor-based video, image, speech, such as the DTV-centric video phone/mail system, as well as and other uses of signal processing.

Digital or sampled data type median filters function by operating on a fixed-length list of data samples. The median filter determines which sample present on the fixed-length list represents a value arithmetically median within the list. For example, the median filter considers each pixel in an image in turn and looks at its nearby neighbors to decide whether or not it is representative of its surroundings. Instead of simply replacing the pixel value with the mean of neighboring pixel values, it replaces it with the median of those values. The median is calculated by first sorting all the pixel values from the surrounding neighborhood into numerical order and then replacing the pixel being considered with the middle pixel value. For example, if the region under consideration contains an even number of pixels, the average of the two middle pixel values is used.

The median filter is implemented via methods of using software and hardware. A method of using software uses a predetermined sorting algorithm in a general-purpose microprocessor or digital signal processor (DSP) to sort data sequence and then obtain data having the middle value among the sorted data sequence. The prior art for implementing the median filter in hardware is disclosed in U.S. Pat. No. 5,138,567. In the case where a median filter is implemented in hardware, it is advantageous to adopt a small number of gates in view of costs and the degree of integration.

There are, however, numerous shortcomings to these types of conventional median filter. Including, to find the median it is necessary to sort all the values in the neighborhood into numerical order and this is relatively slow, even with fast sorting algorithms such as quicksort. Consequently, for real-time applications even with the fast implementations of sorting, they are still not fast enough. Accordingly, any decrease in the complexity of the computation in a median filter or circuit components needed in a processor may improve the over-all speed of the applications requiring such filters.

### BRIEF SUMMARY OF THE INVENTION

It is an object of the present invention to address some of the limitations of conventional median filters within processors, as discussed above.

It is a further object of the invention to provide a median filter processor instruction architecture that reduces the number operations in the median computation. In addition, a method and system to avoid the time-consuming sorting operation, when a limited number of elements is specified for a median filter process. Advantageously, in turn, increasing the overall speed of the median computation in the processor.

The shortcomings associated with median filter computations in a processor are reduced or overcome by an arrangement in accordance with the principles of the present invention. In one embodiment of the present invention, the median filter, with a predetermined number of elements, is constructed by using only two types of processor operations that take only two operands, to be more specific, the maximum and minimum of two.

These and other embodiments and aspects of the present invention are exemplified in the following detailed disclosure.

### BRIEF DESCRIPTION OF DRAWINGS

The features and advantages of the present invention can be understood by reference to the detailed description of the preferred embodiments set forth below taken with the drawings, in which:

FIG. 1 is a block diagram of one illustrative arrangement of a processor-based five-element median filter in accordance with the teachings of the present invention.

### DETAILED DESCRIPTION

Some portions of the detailed descriptions that follow are presented in terms of programs or algorithms and symbolic representations of operations on data bits within a processor. These algorithmic descriptions and representations are the means used by those skilled in the data processing arts to most effectively convey the substance of their work to others skilled in the art. An algorithm is here, and generally, conceived to be a self-confident sequence of steps leading to a desired result. The steps are those requiring physical manipulations of physical quantities. Usually, though not necessarily, these quantities take the form of electrical, magnetic or optical signals capable of being stored, transferred, combined, compared, and otherwise manipulated.

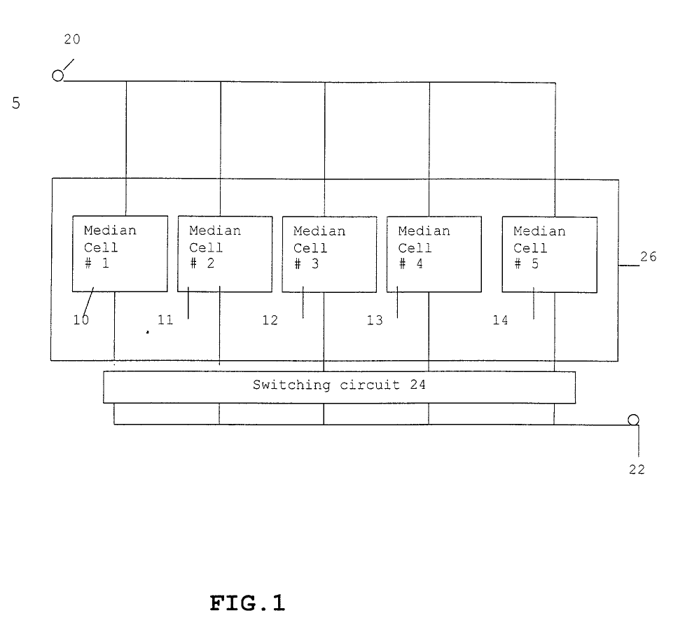

A preferred embodiment of the present invention will be described in detail with reference to the accompanying FIG. 1. In FIG. 1, a constructional block diagram is shown for illustrating one embodiment of a fast five-element median filter in accordance with the teachings of the present invention. It will be recognized that FIG. 1 is simplified for explanation purposes and that the full processor environment suitable for use with the invention will comprise, for example, cache memory, RAM and ROM memory, compiler or assembler, I/O devices, etc., all of which need not be shown here.

Processor 26, such as the Trimedia Processor, for implementing the median filter of FIG. 1 contains the majority of logic, control, supervisory, translation functions required for controlling the median filter operation. Processors of this type typically have special or fast instruction for operations such as maximum and minimum of two. Alternatively, a processor may be upgraded for median filter use by transmitting software or code to implement the predetermined-element median filter and or the maximum and minimum operations.

In the present invention the median of three is constructed using only those two types of operations. Thereafter the median of five is constructed in a similar manner.

Referring to FIG. 1, the median filter according to the embodiment of the present invention is a degree five of a median filter, which is composed of five median cells 10 through 14. The median cells 10 through 14 (hereinafter MS 10-14) are connected to an input end 20; and an output end 22, through a conventional switching circuit 26 (e.g. switches, registers, or cell addressing schemes) to allow data manipulation and intermediary operation storage. Alternatively, (not shown) the conventional switching circuit 24 may be integrated into processor 26.

According to the principles of the present invention, to determine the median of three median cells, let Max(MS10,MS11) denote the maximum of MS10 and MS11; while Min(MS10,MS11) denote the minimum of MS10 and MS11. Then median of 3(MS10,MS11,MS12) is constructed as:

Med3(MS10,MS11,MS12)=Min(Max(Min(MS10,MS11),MS12),M ax(MS10,MS11))

First the Min(MS10,MS11) and Max(MS10,MS11) are determined by comparing MS10 and MS11. Then MS12 is compared with Min(MS10,MS11). Since the smaller one of this comparison is the minimum of 3, thus, it is not the median. The larger one, i.e. Max(Min(MS10,MS11),MS12) is either median or the maximum of MS10,MS11,MS12 and it is exclusive of Max(MS10,MS11). Thereafter, it is further compared with Max(MS10,MS11). We know that the larger one of this comparison is the maximum of the 3, so the smaller of the comparison is the median.

To determine the median of five, the result of median of 3 used and the following method: (1) Maximum of four can never be the median of the group of five, which is formed by adding one more element of the existing group of four; and (2) the minimum of four can never be the median of the group of five, which is formed by adding one more element to the group of the four.

Therefore, the median of five is determined by eliminating the maximum, and minimum of four and then feeding the three elements to the median of three. The method is described:

MED₁=Min(Max(MS10,MS11),Max(MS12,MS13))

MED₂=Max(Min(MS10,MS11),Min(MS12,MS13))

MED₅(MS10,MS11,MS12,MS13,MS14)=MED3(MED1, MED2,MS14)

The MED₅ uses MED₃, which is constructed similarly, as described above.

Advantageously, the five-element median filter is constructed using only two types of operations that take only two operands, to be more specific, the maximum and minimum of two. When used in Media-processor-based systems, for example the Trimedia processor, on which the two operations are implemented as special or fast operations, (known as customer-ops in Trimedia processor), it is fast enough to meet the real-time video/image processing requirement of various applications.

The following merely illustrates the principles of the invention. It will thus be appreciated that those skilled in the art will be able to devise various arrangements which, although not explicitly described or shown herein, embody the principles of the invention and are included within its spirit and scope. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The functions of the various elements shown in FIG. 1, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “server” or “controller” should not be construed to refer exclusively to hardware capable of executing software, and may implicitly include, without limitation, digital signal processor (DSP) hardware, read-only memory (ROM) for storing software, random access memory (RAM) and non-volatile storage. Other hardware, conventional and/or custom, may also be included.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

What is claimed is:

1. A median filter used by a processor, said median filter comprising:
a predetermined number of median cells, each of said median cells is connected to an input and an output; and
means for determining the median of said predetermined number of median cells using only minimum (Min) and maximum (Max) operations of said processor.

2. The median filter of claim 1 , wherein the predetermined number of median cells is five.

3. The median filter of claim 2, wherein the means for determining the median includes a first means for determining the median of three of said predetermined number, said first means is defined by the relationship:
MED₃ (a,b,c)=Min(Max(Min(a,b),c),Max(a,b)).

4. The median filter of claim 3, wherein the means for determining the median includes a second means for determining the median of five of said predetermined number, said second means is defined by the relationship:
MED₅(a,b,c,d,e)=MED3((Min(Max(a,b),Max(c,d))), (Max(Min(a,b),Min(c,d))),e).

5. A method of median filtering a predetermined number of elements in a processor, said method comprising the steps of:
storing the predetermined number of elements in a predetermined number of median cells;
determining the median of said predetermined number of median cells using only minimum (Min)) and maximum (Max) operations of said processor.

6. The method of claim 5, wherein the predetermined number of median cells is five.

7. The method of claim 6, wherein the determining step includes first determining the median of three of said predetermined number, said first determining step is defined by the relationship:
MED₃(a,b,c)=Min(Max(Min(a,b),c),Max(a,b)).

8. The method of claim 7, wherein the determining step further includes secondly determining the median of five of said predetermined number, said second determining step is defined by the relationship:
MED₅(a,b,c,d,e)=MED3((Min(Max(a,b),Max(c,d))), (Max(Min(a,b),Min(c,d))),e).
